(19) United States
(12) Patent Application Publication
(10) Pub. No.: US 2026/0355652 A1
(43) Pub. Date: Nov. 12, 2026

(54) OPTIMIZATION OF MULTIPLE NGL TRAINS USING ECONOMIC OBJECTIVE

(71) Applicant: PHILLIPS 66 COMPANY, Houston, TX (US)

(72) Inventor: Jeffrey Li, Sugar Land, TX (US)

(73) Assignee: PHILLIPS 66 COMPANY, HOUSTON, TX (US)

(21) Appl. No.: 19/673,477

(22) Filed: May 11, 2026

Related U.S. Application Data
(60) Provisional application No. 63/803,193, filed on May 9, 2025.

(51) Int. Cl. B01D 3/14; B01D 3/42; C10G 7/12

(52) U.S. Cl. CPC B01D 3/143; B01D 3/4294; C10G 7/12

(57) ABSTRACT

A process for separating natural gas liquids (NGL) into fractions utilizing multiple NGL fractionation systems, where the separation is optimized using one or more economic objectives that produce the maximum economic value. The total feed rate of NGL to the multiple NGL fractionation systems is constrained to a value that is less than the combined maximum separation capacity of the multiple fractionation systems, and one of the economic objectives calculates the optimal feed rate of the feedstock to each of the multiple fractionation systems. In some embodiments at least one of the multiple fractionation systems has a natural gas liquids separation capacity that is distinct from the others.

### CROSS-REFERENCE TO RELATED APPLICATIONS

This application is a non-provisional application which claims the benefit of and priority to U.S. Provisional Application Ser. No. 63/803,193 entitled Optimization of Multiple NGL Trains Using Economic Objective Functions which was filed on May 9, 2025 and is hereby incorporated by reference in its entirety.

### STATEMENT REGARDING FEDERALLY SPONSORED RESEARCH OR DEVELOPMENT

None.

### FIELD OF THE INVENTION

Economic optimization of natural gas liquids (NGL) separation into fractions utilizing multiple NGL fractionation systems, where at least one NGL fractionation system has an NGL separation capacity that is distinct from the others and the total feed rate of NGL to the multiple NGL fractionation systems is constrained to a value that is less than the combined maximum separation capacity.

### BRIEF SUMMARY

A conventional APC system that controls multiple NGL fractionation trains does not include considerations for optimization of feed distribution to the multiple fractionation trains when the multiple fractionation trains share a single constrained NGL feed source, and one or more of the fractionation trains is built to different specifications from the others. Examples of differences in specification can be (but are not limited to) design differences in NGL separation capacity or design efficiency of separation for two or more NGL components.

What is needed is an effective optimization process that can rapidly determine the optimal distribution of NGL feedstock from a single constrained or limited source to each of multiple NGL fractionation trains where at least one of the fractionation trains is built to different specifications for separating NGLs.

### BRIEF DESCRIPTION OF THE FIGURES

A more complete understanding of the various embodiments may be acquired by referring to the following descriptions along with the accompanying drawings in which:

FIG. 1 is a flow diagram of a typical NGL fractionation train comprising multiple separation columns.

FIG. 2 is a flow diagram of a typical NGL fractionation train comprising multiple separation columns.

FIG. 3 is a flow diagram of a process optimization scheme for an NGL fractionation train comprising multiple separation columns.

FIG. 4 is a graph depicting hypothetical examples of various process models related to the operation of a depropanizer top section, expressed as algebraic equations.

FIG. 5 depicts sensitivity plots that show optimal target separation parameters for each column in a five column NGL fractionation train.

FIG. 6 is a flow diagram of a process optimization scheme for NGL fractionation comprising multiple NGL fractionation trains.

FIG. 7 is a graph depicting the non-linear relationship between the total NGL feed rate available and the optimal quantity of NGL to be fed to each of four separate NGL fractionation trains.

FIG. 8 is a graph depicting the non-linear relationship between the total NGL feed rate available and the optimal separation of key NGL components to achieve maximum economic profit.

FIG. 9 is a graph depicting the non-linear relationship between the total NGL feed rate available and lost product opportunity for a key component of NGL.

The inventive processes and systems may comprise various modifications and alternative forms, only some of which are illustrated in the drawings. The drawings may not be to scale.

### DETAILED DESCRIPTION

Natural Gas Liquids (NGLs) are hydrocarbons found in natural gas that include ethane, propane, butanes, and natural gasoline. NGLs are crucial in the energy sector, serving as feedstocks for petrochemical production, fuels for heating and transportation, and components in various industrial applications.

When natural gas is extracted from a well, it often contains a mixture of gases known as raw natural gas. This mixture includes methane and NGLs. Fractionation is the process of separating these NGLs into individual components based on their boiling points. This separation is essential because, 1) Different NGLs have distinct physical properties, making it challenging to store them at the right temperature and pressure when mixed; 2) Many industries require specific NGLs in pure form to meet product standards.

NGL fractionation typically occurs in multiple fractionation towers, also known as a distillation columns. The process involves several key steps, including treating raw natural gas to remove impurities such as water, sulfur compounds, and carbon dioxide. This ensures that the fractionation process is efficient and that the final products are of high quality. The treated gas is then separated in a series of fractionation towers, with each tower responsible for separating and purifying different component of the NGL feed (e.g., ethane, propane, etc.)

The first column in the system is the de-ethanizer, which separates ethane from the rest of the NGL mixture. The feed enters the column, where it is heated. Ethane, having the lowest boiling point, vaporizes and rises to the top of the column, where it is condensed and collected. The de-ethanized effluent moves to the de-propanizer column. Here, propane is separated from the mixture. Propane vaporizes and is collected at the top of the column, while the heavier components continue to the next stage. The next column that receive the de-propanized effluent is the de-butanizer, which separates butanes from the mixture. Butanes vaporize and are collected at the top, leaving the heavier components to move to the final stage. In some systems, a butane splitter is used to further separate normal butane from isobutane. This column operates similarly to the previous ones, ensuring that each type of butane is collected separately. The remaining C5+ liquid effluent comprises natural gasoline and is collected at the bottom of the de-butanizer column.

Each distillation column is equipped with additional equipment including a reboiler at the bottom, which heats the feed to vaporize the components. At the top of each column, condensers cool the vaporized components, allowing them to condense and be collected. Finally, receivers are vessels where the condensed liquids are collected and stored before further processing or transportation. Advanced control systems (ACS) monitor the system and adjust the temperature, pressure, and flow rates within the columns to optimize the NGL fractionation process.

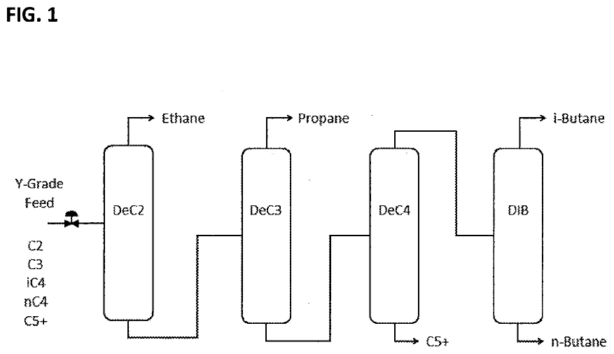

A simplified natural gas liquids (NGL) fractionation process flow diagram is shown in FIG. 1. The methods described in this document are related to the optimization of a single NGL fractionation train as well as multiple fractionation trains.

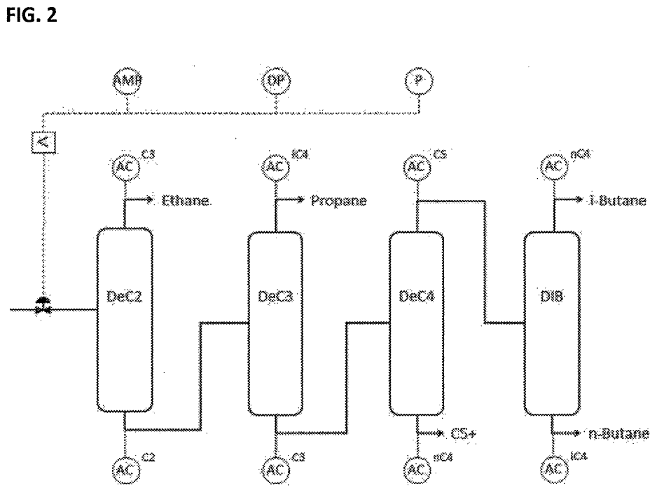

Typical advanced process control (APC) for natural gas liquid (NGL) fractionation includes composition controllers located at both the top exit and bottom exit of distillation columns that together comprise the fractionation train. FIG. 2 shows the general location of these “analyzer control” (AC) units. The control algorithm in the APC can be PID (proportional, integral, and derivative), model-based DMC from Aspentech™, or a deep-learning neural network. Inferential signals based on combinations of temperatures and pressures are often used to replace analyzer signals. This eliminates the delay of online NGL analysis, (e.g., up to 20 min for gas chromatography analysis of NGL composition).

Many APC systems for NGL processes include a feed maximizer function that operates to continuously increase the feed rate of the incoming NGL feedstock until the fractionation system reaches the maximum flow rate of NGL feedstock that NGL fractionation apparatus can effectively separate. Typical constraints observed for an NGL fractionation process include (but are not limited to) compressor motor amperages, fractionation tower differential pressure (DP), and compressor discharge pressure.

A conventional APC system that controls an NGL fractionation train does not include considerations for total operating costs or market prices of products. Conventional optimization within the APC is based on predetermined sequential priorities without the formulation of economic objective functions. A conventional APC (1) controls product compositions, (2) maximize throughput of feedstock. Optimization for other factors (e.g, maximizing monetary profitability) is typically performed in another layer of application on top of APC and is carried out separately by either linear programming (LP) or nonlinear programming (NLP). A typical operator's interface for APC and optimization of a multi-column NGL fractionation system includes the ability to visualize and control target compositions of the fractions exiting each column. The overall rate of feedstock flow is typically limited to the maximum rate of the at which the most limited-capacity column (e.g., depropanizer) can operate. The APC operator interface also allows adjustment of optimization targets (in vol. %) for production of NGL components from each column in the fractionation system.

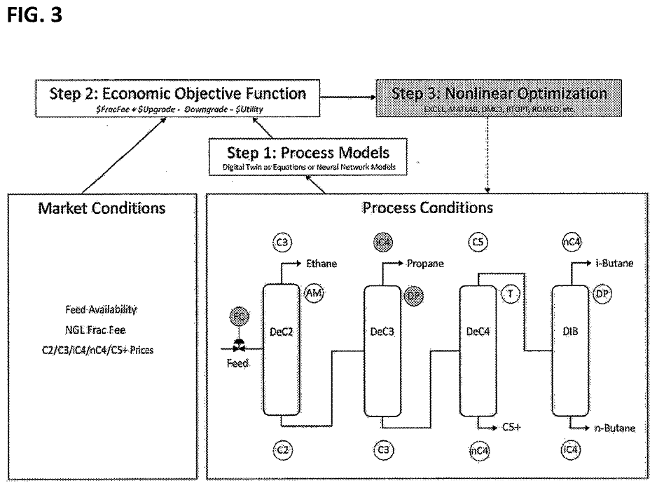

In conventional systems, the optimization calculation producing these target percentages is performed outside of the APC programming on a separate computing device (i.e., offline) and consists of three major steps, as shown in FIG. 3, (where FC=feed control, T=temperature, Amp=amperage, DP=differential pressure, C2=ethane, C3=propane, iC4=isobutane, and nC4=n-butane). Step 1 involves the creation and calibration of process models which are based on historical process data; for example, three years' worth of 100 different process measurements at one-hour intervals may be used.
Step 2 in the process to optimize fractionation target percentages for each of the hydrocarbon components in an NGL stream incorporates economic costs as well as the current sales price for the separated products. For example, the cost for electricity to run the process, the cost per barrel to buy the NGL feedstock, offset by the income from the sale of the separated NGL components (e.g., ethane, propane, iso-butane, n-butane, C5+ natural gasoline, etc.) The output of the economic objective function is a numeric value, which is subsequently used in Step 3 of the optimization.
Step 3 in the process to optimize fractionation target percentages is a non-linear optimization that can be done manually or using commercially available modeling software such as the GRG Nonlinear Solver (Microsoft™) and the DCM3 Nonlinear CV Solver (Aspentech™). In one example the process optimizes a small subset of the single NGL train, focusing on the optimization of the depropanizer column top section (i.e., the top 20 trays column). In some embodiments, non-linear optimization utilizes a deep learning model for optimization, such as (but not limited to) Recurrent Neural Networks (RNNs), Long Short-Term Memory (LSTM) Networks, Transformers, Autoencoder, Generative Adversarial Networks (GANs), Multilayer Perceptron (MLP) and any other deep learning model.

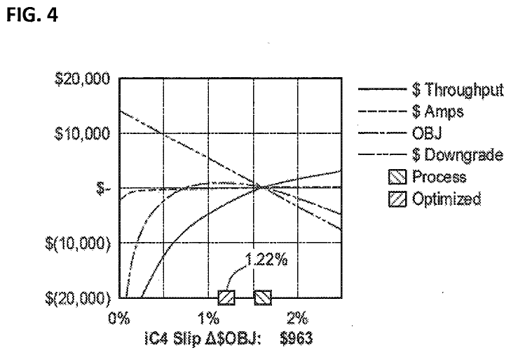

FIG. 4 depicts hypothetical examples of various process models related to the operation of a depropanizer top section, expressed as algebraic equations: A.) Fractionation. B.) Loading, and C.) Energy Utilized. Such models have historically been expressed as algebraic equations. More recently, machine learning is optionally utilized to develop such process models. These models are optionally calibrated on a constant or intermittent basis by incorporating recently-obtained data to allow such process models to more closely match the most recent process measurements.

In the example depicted in FIG. 4, the optimization routine iteratively adjusts iC4 composition and depropanizer feedstock targets to find the maximum possible economic profit that simultaneously considers feedstock and energy costs while maximizing yields of the most valuable fractionated components. The solver routine can also account for limitations placed on the depropanizer equipment, such limits on discharge pressure.

More specifically, FIG. 4 depicts a specific example of optimizing the quantity of iC4 (in vol. %) that co-migrates in the propane fraction produced by an NGL fractionation process in order to maximize monetary profit. In the graph, the $Throughput variable tracks how increasing flow through the depropanizer increases the percentage of iC4 that co-separates with the propane fraction (x-axis) but also increases net monetary profit (y-axis). The $Amps variable tracks how overall energy costs remain relatively constant versus the percentage of iC4 co-separates with the propane fraction. The $Downgrade variable tracks lost profit due to increasing percentage of iC4 co-separating with the propane fraction. From the graph of the OBJ function, the maximum value (i.e., profit) is found when the depropanizer is run in a manner that causes 1.22 vol % of iC4 to co-separate with the propane that leaves the top of the depropanizer.

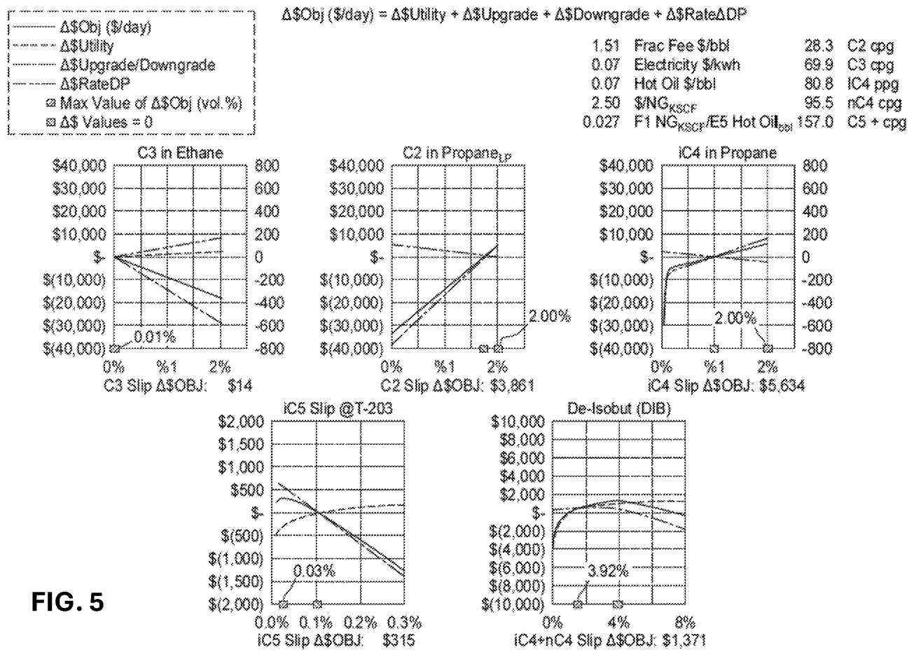

The concept of optimization demonstrated in FIG. 4 covers a single composition target for just one portion of an NGL fractionation process. However, the same data analysis routine discussed above can be extended to as many targets as needed for a single NGL train. Optimization using economic objective functions for an entire NGL train is often utilized, where five or more optimized targets for separation of NGL components are utilized for four distillation columns that comprise an NGL fractionation system. The sensitivity of economic objectives to various target compositions is displayed in FIG. 5. These sensitivity plots are developed to allow users to visually inspect and validate optimized targets, defined as the point where the $OBJ function reaches its maximum value (shown by the black line). The plot of the $OBJ function equals the sum of all other economic functions at a particular value for the co-migration of one component with another. In the example shown in FIG. 5, the optimized target values (in vol. %) are listed beneath each graph for a process where the controlling limitation was providing the maximum rate to the depropanizer where the pressure differential (DP) leaving the top of the depropanizer is 3.2 psig or less. Looking at each graph (from left to right) maximum net profit was obtained when the quantity of propane that co-fractionates with the ethane is 0.01 vol. %, when the quantity of ethane that co-fractionates with the propane is 2.00 vol. %, when the quantity of isobutane that co-fractionates with the propane is 2.00 vol. %, when the quantity of isopentane that co-fractionates with the mixed butanes (n-butane and iso-butane) is 0.03 vol. %, and when the quantity of n-butane that co-fractionates with the pentane is 3.92 vol. %.

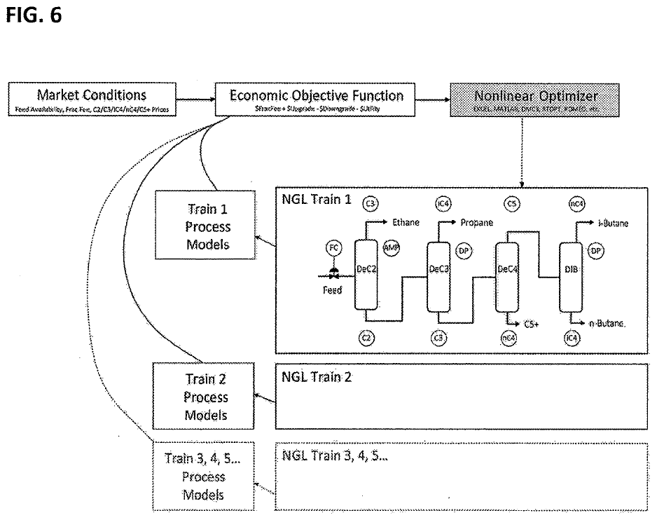

Some embodiments comprise performing the optimization using multiple economic objective functions across multiple NGL fractionation trains that derive their NGL feedstock from the same source (e.g., pipeline or storage tank). An example of such an embodiment is shown in FIG. 6. In a first step, current (or recent) market conditions can be incorporated into the models, including (but not limited to) variables such as NGL feed availability, fee income per barrel of NGL fractionated into its component hydrocarbons and market prices for the sale of any of ethane, propane, isobutane, n-butane, or C5+ natural gasoline. In a second step, this market conditions data can be incorporated into an Economic Objective Function that finds the most optimal operating conditions for each of the multiple NGL fractionation trains that provides the maximum economic benefit. This optimizing process can be performed using non-linear algebraic equation models such as can be found in commercially available software (e.g., Microsoft Excel™, Mathworks' MATLAB™, Aspentech DMC3™, etc.). Alternatively, the optimizing process can be performed utilizing “deep learning” neural network algorithms, such as (but not limited to) Recurrent Neural Networks (RNNs), Long Short-Term Memory (LSTM) Networks, Transformers, Autoencoder, Generative Adversarial Networks (GANs), Multilayer Perceptron (MLP) and any other deep learning model.

In some embodiments, the multiple fractionation trains may have varying specifications for NGL separation, resulting in differing separation capacities or separation efficiencies at certain points in the fractionation process. The optimization process can also be utilized to determine the optimal distribution of a constrained (or limited) feed rate of NGL feedstock to each fractionation train based upon the variables of capacity and efficiency for each fractionation train. In these embodiments, the term limited means that the feed rate of the NGL feedstock is less than the total capacity of the multiple fractionation trains that all receive NGL feedstock from a single supply line or storage vessel.

For an embodiment with four NGL trains included in the same optimization routine, the overall objective function becomes:
{OBJ_FEE}Frac1+{OBJ_YIELD}Frac1+{OBJ_KEV}Frac1+{OBJ_FEE}Frac2+{OBJ_YIELD}Frac2+{OBJ_KEV}Frac2+{OBJ_FEE}Frac3+{OBJ_YIELD}Frac3+{OBJ_KEV}Frac3+{OBJ_FEE}Frac4+{OBJ_YIELD}Frac4+{OBJ_KEV}Frac4
Where:
   OBJ_FEE represents the processing fee each Frac Train earns per barrel of NGL fractionated;
   OBJ_KEV represents energy costs for the process, largely electricity costs for process compressors; and
   OBJ_YIELD represents the economic value of the fractionated products.
Each of the above terms is defined by the following formula:
   OBJ_FEE Formula: {FEEDx}*{FRACFEE_$BBL} NOTE: Where x is a value 1-4 corresponding to the feed rate to a given fractionation train (e.g., Frac 1, 2, 3 or 4).
   OBJ_YIELD Formula: {D_EO}*{IC4}/100*42*({C3_CPG}−{IC4_CPG})/100
   OBJ_KEV Formula: −{AMP_EO}*6400/1000*1.732*{CKWH}/100
   OBJ Formula: {OBJ_FEE}+{OBJ_YIELD}+{OBJ_KEV}

In these Formula,
FRACFEE_$BBL represents the fee income of the fractionation train in price per barrel;
D_EO represents the volume of propane product in BPH;
AMP_EO represents the electrical energy required to operate the fractionation process;
CKWH represents electricity cost in cents per kilowatt-hour.
FEEDx represents the NGL feed rate to each fractionation train of the four trains included in the function.
   When the overall feed rate to the multiple fractionation trains is constrained to a specific value, (i.e., all fractionation trains must make the most economically valuable use of a limited quantity of NGL feed) a new constraint for the overall objective function is added, where FEED1+FEED 2+FEED3+FEED4=Total NGL Feed Rate in barrels per hour (BPH). This can provide additional value in scenarios where one or more of the fractionation trains is built to different specifications and therefore potentially has different constraints on the efficiency of separating one or more components of an NGL feedstock. In such situations, adding this constraint to the optimization routine allows the feed rate to each fractionation train to vary freely in order for the optimization function to determine the optimal feed rate to each frac train that provides the largest overall economic benefit.

### EXAMPLES

The following non-limiting examples are provided to further illustrate aspects described herein. However, the example is not intended to be all-inclusive and is not intended to limit the scope of the specific embodiment described. The particular materials and amounts thereof, as well as other conditions and details recited in these examples should not be used to limit the implementations of the process described herein.

### EXAMPLE

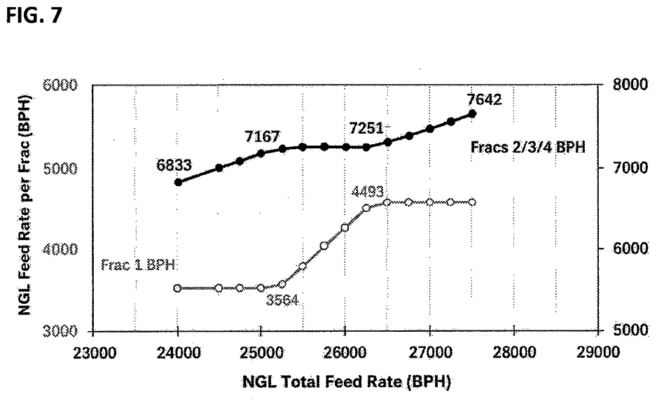

In this example, an NGL fractionation system comprises four separate NGL fractionation trains (Fracs). The Frac 1 is built to different specifications than Frac 2, Frac 3 and Frac 4. The four Fracs share a common NGL feedstock supply that is 27,000 (BPH). The objective function was optimized using non-linear algebraic equation models found in commercially available Aspentech DMC3® software. FIG. 7 illustrates the overall results of optimizing the overall Economic Objective function to incorporate economic objectives for each of multiple NGL fractionation trains including an objective to find the optimal distribution of NGL feedstock among the four fractionation trains. FIG. 7 shows the best solution is non-linear in nature and that at 27,000 BPH of feedstock maximum economic profit was obtained with a target feed rate of 4573.9 BPH to Frac 1, and 7475.4 BPH target feed rate to each of Fracs 2, 3 and 4.

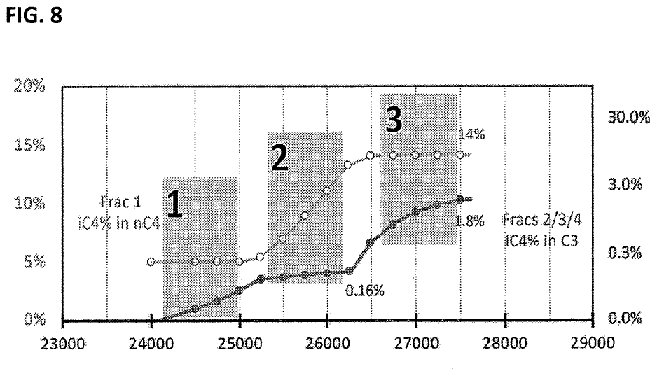

FIG. 8 again demonstrates the non-linear nature of the optimal solution for one of the underlying economic considerations in the overall objective function. The graph shows the optimized target percentage of iC4 to be allowed to co-separate with nC4 and leave via the bottom of the iso-debutanizer column for Frac1 (light yellow) and the optimized target iC4 to be allowed to co-separate with C3 and leave via the top of the depropanizer column for Fracs 2, 3 and 4. The graph demonstrates that when increasing the total NGL feed rate from 24,000 to 25,000 BPH (highlighted region 1) the most economically profitable solution is to increase target iC4 co-separation with C3 for Fracs 2-4, while keeping the target iC4 co-separation with nC4 in Frac 1 relatively constant. However, in a second feed rate region from 25,250 to 26,250 BPH the opposite is true. Lastly, as NGL feed rate increases from about 26,500 to 27,500 BPH the most economically profitable solution is to again increase target iC4 co-separation with C3 for Fracs 2-4, while keeping the target iC4 co-separation with nC4 in Frac 1 relatively constant. The non-linear nature of the optimization demonstrates the complex relationship between distribution of a limited quantity of feed to multiple fractionation trains, when different fractionation trains have different separation capacities and/or efficiencies.

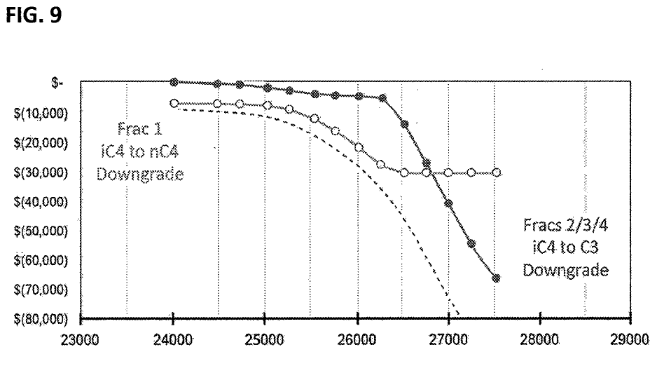

FIG. 9 provides a visual means to validate the optimized mathematical solution provided by the present process. The line indicated by solid circles represents the monetary economic loss due to co-separation of iC4 with nC4 in Frac 1 as total NGL feed rate increases, while the line indicated by open circles indicates the monetary economic loss due to co-migration of iC4 with C3 in Fracs 2, 3 and 4 as the total NGL feed rate increases. The dotted line represents the sum of the monetary economic loss and demonstrates the smooth continuous nature of the overall trend (total economic loss) despite the relatively convoluted plots of economic losses contributed by loss of individual NGL components via co-migration with other components.

The descriptions of the various aspects of the present disclosure have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects disclosed herein. While the foregoing is directed to aspects of the present disclosure, other and further aspects of the present disclosure can be devised without departing from the basic scope thereof.

### Illustrative Embodiments

The following is a description of various embodiments of the disclosed subject matter. Each embodiment may include one or more of the various features, characteristics, or advantages of the disclosed subject matter. The embodiments are intended to illustrate a few aspects of the disclosed subject matter and should not be considered a comprehensive or exhaustive description of all possible embodiments.

A first illustrative embodiment comprises a process for separating natural gas liquids, comprising: a) directing a feedstock comprising natural gas liquids to multiple fractionation systems and separating the feedstock into fractions in each of the multiple fractionation systems, where each fraction comprises one or more hydrocarbons having a carbon number in the range from C2 to C5 with a residual quantity of C6+ hydrocarbons, where each fractionation system is capable of independently separating natural gas liquids into hydrocarbon components; b) optimizing the separating of the feedstock into fractions using one or more economic objectives that produce the maximum economic value from the multiple fractionation systems as a whole, where the total feedstock feed rate to the multiple fractionation systems is constrained to a value that is less than the combined maximum separation capacity of the multiple fractionation systems, and where one of the economic objectives calculates the optimal feed rate of the feedstock to each of the multiple fractionation systems.

A second embodiment comprises the process of embodiment 1, where one of the economic objectives is the monetary fee income per volume of natural gas liquids separated.

A third embodiment comprises the process of any of embodiments 1-2, wherein one of the economic objectives is the cost of energy required to separate the natural gas liquids.

A fourth embodiment comprises the process of any of embodiments 1-3, where one of the economic objectives is the monetary income from sale of separated hydrocarbon products derived from separating the feedstock.

A fifth embodiment comprises the process of any of embodiments 1-4, where at least one of the multiple fractionation systems has a natural gas liquids separation efficiency that is distinct from the others, wherein separation efficiency is defined as the ability to separate any two components of the natural gas liquids feedstock.

A sixth embodiment comprises the process of any of embodiments 1-5, where at least one of the multiple fractionation systems is located at a different geographic location from the other fractionation systems.

A seventh embodiment comprises the process of any of embodiments 1-6, where the optimization is a machine learning non-linear optimization that utilizes a deep learning algorithm.

An eighth embodiment comprises the process of any of embodiments 1-7, where the deep learning model is a neural network algorithm.

A ninth embodiment comprises the process of any of embodiments 1-8, where the deep learning model is a neural network algorithm selected from Recurrent Neural Networks, Long Short-Term Memory Networks, Transformers, Autoencoder, Generative Adversarial Networks, Multilayer Perceptron and any other deep learning algorithm capable of optimizing the overall economic value of the process.

### General Terminology and Interpretative Conventions

Any methods described in the claims or specification should not be interpreted to require the steps to be performed in a specific order unless expressly stated. The methods should be interpreted to provide support to perform the recited steps in any order unless expressly stated otherwise.

Certain features described in the context of separate embodiments can also be implemented in combination in a single embodiment. Conversely, various features that are described in the context of a single embodiment can also be implemented in multiple embodiments separately or in any suitable sub-combination. Moreover, although features may be described above in certain combinations and even initially claimed as such, one or more features from a claimed combination can be excised from the combination, and the claimed combination may be directed to a sub-combination or variation of a sub-combination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of,” “consisting of the recited subject matter plus impurities and/or trace amounts of other materials,” or “consisting essentially of.”

All disclosed ranges are to be understood to encompass and provide support for claims that recite any subranges or any individual values subsumed by each range. For example, a stated range of 1 to 10 should be considered to include and provide support for claims that recite any sub-ranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, terms such as “processing,” “computing,” “calculating,” “determining,” “displaying,” or the like, refer to the action and processes of an electronic computing device including a processor and memory.

The subject matter recited in the claims is not coextensive with and should not be interpreted to be coextensive with any embodiment, feature, or combination of features described or illustrated in this document. This is true even if only a single embodiment of the feature or combination of features is illustrated and described.

1. A process for separating natural gas liquids, comprising:
(a) directing a feedstock comprising natural gas liquids to multiple fractionation systems and separating the feedstock into fractions in each of the multiple fractionation systems,
wherein each fraction comprises one or more hydrocarbons having a carbon number in the range from C2 to C5 with a residual quantity of C6+ hydrocarbons,
wherein each fractionation system is capable of independently separating natural gas liquids into hydrocarbon components;
(b) optimizing the separating of the feedstock into fractions using one or more economic objectives that produce the maximum economic value from the multiple fractionation systems as a whole,
wherein the total feedstock feed rate to the multiple fractionation systems is constrained to a value that is less than the combined maximum separation capacity of the multiple fractionation systems, and
wherein one of the economic objectives calculates the optimal feed rate of the feedstock to each of the multiple fractionation systems.

2. The process of claim 1, wherein one of the economic objectives is the monetary fee income per volume of natural gas liquids separated.

3. The process of claim 1, wherein one of the economic objectives is the cost of energy required to separate the natural gas liquids.

4. The process of claim 1, wherein one of the economic objectives is the monetary income from sale of separated hydrocarbon products derived from separating the feedstock.

5. The process of claim 1, wherein at least one of the multiple fractionation systems has a natural gas liquids separation efficiency that is distinct from the others, wherein separation efficiency is defined as the ability to separate any two components of the natural gas liquids feedstock.

6. The process of claim 1, wherein at least one of the multiple fractionation systems is located at a different geographic location from the other fractionation systems.

7. The process of claim 1, wherein the optimization comprises a non-linear algebraic equation optimization.

8. The process of claim 1, wherein the optimization is a machine learning non-linear optimization that utilizes a deep learning algorithm.

9. The process of claim 1, wherein the deep learning model is a neural network algorithm.

10. The process of claim 6, wherein the deep learning model is a neural network algorithm selected from Recurrent Neural Networks, Long Short-Term Memory Networks, Transformers, Autoencoder, Generative Adversarial Networks, Multilayer Perceptron and any other deep learning algorithm capable of optimizing the overall economic value of the process.
